(19) United States
(12) Patent Application Publication
(10) Pub. No.: US 2004/0095458 A1
(43) Pub. Date: May 20, 2004

(54) RIBBON CASSETTE WITH IDENTIFIED DEVICE

(76) Inventor: Chien-Chih Chen, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/248,552

(22) Filed: Jan. 29, 2003

(30) Foreign Application Priority Data
Nov. 15, 2002 (TW) 091218446

(51) Int. Cl. B41J 32/00; G01D 15/16; B41J 35/28

(52) U.S. Cl. 347/214; 400/207

(57) ABSTRACT

A ribbon cassette installed within a printer having a sensor for detecting the ribbon cassette. The ribbon cassette contains a front saving room, a back saving room, a take-up spool rotatably installed in the back saving room, a feed spool rotatably installed in the front saving room, a ribbon, and a monolithic protrusion set on the front side of the front saving room. If the protrusion is detected by the sensor, the printer is able to print.

### BACKGROUND OF INVENTION

1. Field of the Invention

The invention relates to a ribbon cassette for use in a printer, more specifically, a ribbon cassette capable of being recognized for use in a thermal transfer printer.

2. Description of Background

Differing from a printer making use of a cassette, despite almost identical configuration, ink jet printers use liquid ink rather than a solid ribbon. Most of the ink jet printers are used in half tone mode, which fails to show continuous hues of real photo pictures. The material of the ribbon is a transparent celluloid paper with wax and color dyes, taking the thermal printer sublimating color dyes on a photo picture for an example. The thermal print head heats the wax and color dyes on the ribbon, and due to a temperature change, the color dye is temporarily liquefied and is transferred onto the photo paper. Then, the color dyes are cooled and thus fixed on the photo paper to impart a colorful image.

The ribbon is installed on a ribbon cassette for use in the thermal printer, the ribbon has a plurality of sequentially arranged color frames, each color frame has dye frames respectively for yellow, magenta, cyan, and an overcoating.

Please refer to FIG. 1 and FIG. 2. FIG. 1 is a schematic diagram of a conventional printer 8. FIG. 2 is a schematic diagram of a conventional ribbon cassette 10. The conventional ribbon cassette 10 includes a front saving room 12, a back saving room 13, a feed spool 14 rotatably installed in the front saving room 12, a take-up spool 16 rotatably installed in the back saving room 13, and a ribbon 18 rolled up on the two spools 14, 16. The front saving room 12 and the back saving room 13 each have a slot 20 through which the ribbon 18 can be passed for convenience to roll up onto the two spools 14, 16.

While the conventional ribbon cassette 10 is installed into the thermal transfer printer 8 for printing, the printer 8 is rolling up the ribbon 18 within the ribbon cassette 10 in such a way that the take-up spool 16 is rotating in a counterclockwise direction, meanwhile, the feed spool 14 is also rotating in the counterclockwise direction and through the slot 20 of the front saving room 12. In this way, each dye frame 15 of color frames on the ribbon 18 is sequentially passing through a thermal print head 17 so as to sublimate the color dyes on the dye frame 15 onto a photo picture. Finally, the used ribbon 18 can be rolled up on the take-up spool 16.

The user can hardly recognize the quality of the ribbon from the cassette appearance due to exquisite counterfeits. In order to avoid using a fake ribbon cassette to and creating poor prints, an identified means should be installed on the ribbon cassette. Hence, the user is capable of preventing from using a wrong ribbon cassette through the detection ability of the printer.

### SUMMARY OF INVENTION

It is therefore a primary objective of the claimed invention to solve the abovementioned problems by providing a ribbon cassette with a means of being -recognized by the printer in use.

In the present invention, the ribbon cassette installed within a printer has a sensor for detecting the ribbon cassette. The ribbon cassette comprises a front saving room, a back saving room, a take-up spool rotatably installed in the back saving room, a feed spool rotatably installed in the front saving room, a ribbon, and a monolithic protrusion set on the front side of the front saving room. If the protrusion is detected by the sensor, the printer is capable of printing.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a conventional thermal printer.

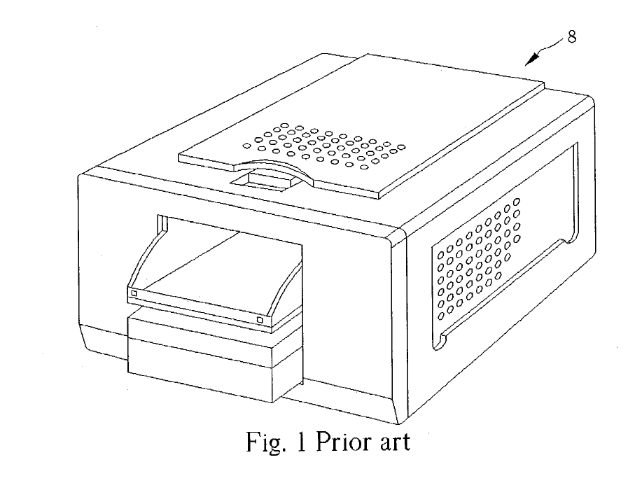

FIG. 2 is a schematic diagram of a conventional ribbon cassette.

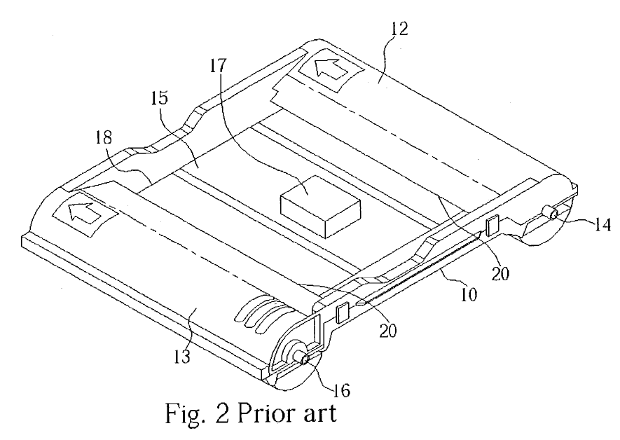

FIG. 3 is a schematic diagram of a thermal printer using a ribbon cassette according to the present invention.

FIG. 4 is a schematic diagram of the ribbon cassette according to the present invention.

### DETAILED DESCRIPTION

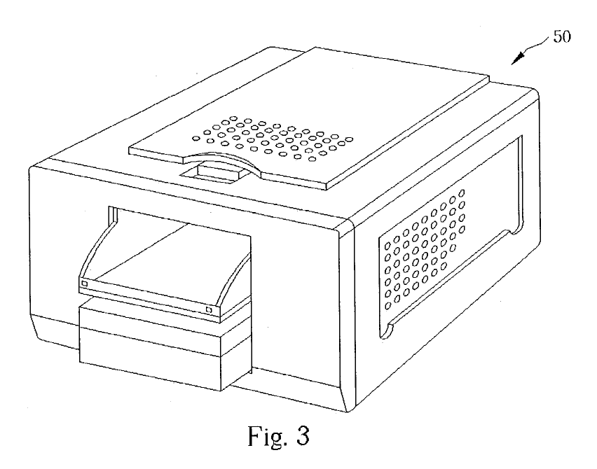

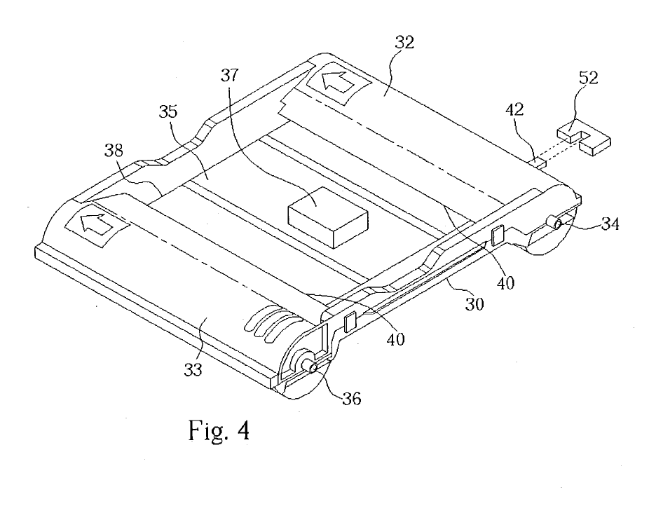

Please refer to FIG. 3 and FIG. 4. FIG. 3 is a schematic diagram of a thermal printer 50 using a ribbon cassette 30 according to the present invention. FIG. 4 is a schematic diagram of the ribbon cassette 30 according to the present invention. As shown in FIG. 4, the ribbon cassette 30 includes a front saving room 32, a back saving room 33, a feed spool 34, a take-up spool 36, a ribbon 38 fed through slots 40 of the front saving room 32 and the back saving room 33 rolling up on the feed spool 34 and the take-up spool 36, and a monolithic protrusion 42 set on front side of the front saving room 32. The feed spool 34 for taking the non-use ribbon 38 and the take-up spool 36 for taking the used ribbon 38 are respectively installed in the front saving room 32, and the back saving room 33. The material of the ribbon cassette 30 is recyclable, such as an acrylonitrile-butadiene-styrene copolymer (ABS). The ribbon 38 has a plurality of sequentially arranged color frames 35 of printing dye. Each color frame 35 has four dye frames with yellow, magenta, cyan, overcoating, and both the front edge and the back edge thereof have an opaque region.

The ribbon cassette 30 is used in a printer 50, such as a thermal transfer printer, a thermal wax printer, a barcode printer, a thermal printer, and a dot matrix printer. The printer 50 further includes a sensor 52. Before the ribbon cassette 30 is installed into the printer 50, the sensor 52 cannot detect any protrusion 42, resulting in the printer 50 not being available for printing. After the ribbon cassette 30 is installed into the printer 50, if the protrusion 52 is still not detected by the sensor 52, the printer 50 remains idle. If the protrusion 52 is detected, the printer 50 is capable of printing. Meanwhile, the user can be notified whether the type of the ribbon cassette 30 is suitable to the printer 50 or what colors of the printing dye are available via the computer being manipulated by the user. During printing, the ribbon 38 within the ribbon cassette 30 is being simultaneously rolled up by the feed spool 34 and the take-up spool 36 so as to keep a constant linear velocity or a constant angular velocity, and passes through the slot 40. Then the thermal print head 37 heats the color frame with the plurality of different color dyes and sublimates the color dyes on a photo picture.

In contrast to the conventional ribbon cassette, the ribbon cassette of the claimed invention is capable of detecting the monolithic protrusion to quickly determine whether the ribbon cassette is suitable to the printer via the sensor thereof. Due to simple structure, the ribbon cassette of the claimed invention will not create an extra cost.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A ribbon cassette installed within a printer, the printer further comprising a sensor for detecting the ribbon cassette, the ribbon cassette comprising:
a front saving room;
a back saving room;
a take-up spool rotatably installed in the back saving room;
a feed spool rotatably installed in the front saving room;
a ribbon fed through slots of the back saving room and the front saving room so as to be rolled up on the take-up spool and the feed spool; and
a monolithic protrusion set on the front side of the front saving room;
wherein before the ribbon cassette is installed into the printer, the sensor is incapable of detecting any protrusion, resulting in the printer not being capable of printing; after the ribbon cassette is installed into the printer, if the protrusion is still not detected by the sensor, the printer remains being idle, and if the protrusion is detected by the sensor, the printer is capable of printing.

2. The ribbon cassette of claim 1 wherein the printer is a thermal transfer printer, a thermal wax printer, a barcode printer, a thermal printer, or a dot matrix printer.

3. The ribbon cassette of claim 1 wherein the feed spool is used for holding an unused portion of the ribbon and the take-up spool is for holding a used portion of the ribbon.

4. The ribbon cassette of claim 1 wherein the material of the ribbon cassette is a recyclable acrylonitrile-butadiene-styrene copolymer (ABS).
